(19) United States
(12) Patent Application Publication
(10) Pub. No.: US 2009/0268452 A1
(43) Pub. Date: Oct. 29, 2009

(54) LIGHT EMITTING DIODE LAMP

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/255,653

(22) Filed: Oct. 21, 2008

(30) Foreign Application Priority Data
Apr. 23, 2008 (CN) 200810066781.9

(51) Int. Cl. F21V 7/06

(52) U.S. Cl. 362/235

(57) ABSTRACT

An LED lamp includes a reflecting portion and a plurality of LEDs. The reflecting portion is formed by rotating a half-parabola, a whole parabola of which has a vertex and a focal point located on the X-axis. The half-parabola extends from the vertex to the Y-axis, and rotates around the Y-axis to form the reflecting portion. The focal points of the half-parabolas of the reflecting portion form an arc-shaped trajectory, the vertexes of the half-parabolas of the reflecting portion form an arc and defining a first open side, and two outmost half-parabolas of the reflecting portion form a second open side of the reflecting portion. The plurality of LEDs are located on the trajectory, and face the reflecting portion. Light emitted by the plurality of LEDs travels to the reflecting portion and then is reflected parallelly therefrom to the second open side.

### BACKGROUND

1. Field of the Disclosure

The disclosure generally relates to a light emitting diode lamp, and particularly to a light emitting diode lamp with uniform light distribution.

2. Description of Related Art

In recent years, light emitting diodes (LEDs) have been widely used in illumination. However, the LED is a point light source, and an emitting surface thereof is usually hemispherical. An intensity of a light field of the LED decreases gradually and outwardly along a radial direction thereof, i.e., the intensity of the light field of the LED is uneven, being strong at a center of the light field and being weak at a periphery of the light field of the LED.

For the foregoing reasons, therefore, there is a need in the art for an LED lamp which overcomes the limitations described.

### SUMMARY

According to an embodiment of the disclosure, an LED lamp includes a substrate, a mounting base, a reflecting cover, a transparent sealing cover, and a plurality of LEDs. The reflecting cover includes a reflecting portion formed by rotating a half-parabola. A whole parabola which has the half-parabola has a vertex and a focal point located on the X-axis. The half-parabola extends from the vertex to the Y-axis, and rotates around the Y-axis to form the reflecting portion. The focal points of the half-parabolas of the reflecting portion form an arc-shaped trajectory, the vertexes of the half-parabolas of the reflecting portion form an arc and define a first open side of the reflecting cover, and two outmost half-parabolas of the reflecting portion form a second open side of the reflecting cover. The substrate couples to and seals the first open side of the reflecting cover, and the sealing cover couples to and seals the second open side of the reflecting cover. A sealed space is defined among the substrate, the sealing cover, and the reflecting cover. The mounting base is received in the sealed space. The trajectory is located on an outer surface of the mounting base, and the plurality of LEDs are located on the trajectory and face the reflecting cover. Light emitted by the plurality of the LEDs travels to the reflecting portion of the reflecting cover and then is reflected parallelly therefrom to the sealing cover.

Other advantages and novel features of the disclosure will be drawn from the following detailed description of the exemplary embodiments of the disclosure with attached drawings.

### BRIEF DESCRIPTION OF THE DRAWINGS

FIG. 1 is an assembled view of a light emitting diode lamp according to an exemplary embodiment;

FIG. 2 is a cross sectional view of the light emitting diode lamp taken along line II-II of FIG. 1.

FIG. 3 is an exploded view of the light emitting diode lamp of FIG. 1.

FIG. 4 is an enlarged view of a mounting base of the light emitting lamp.

### DETAILED DESCRIPTION OF THE EMBODIMENTS

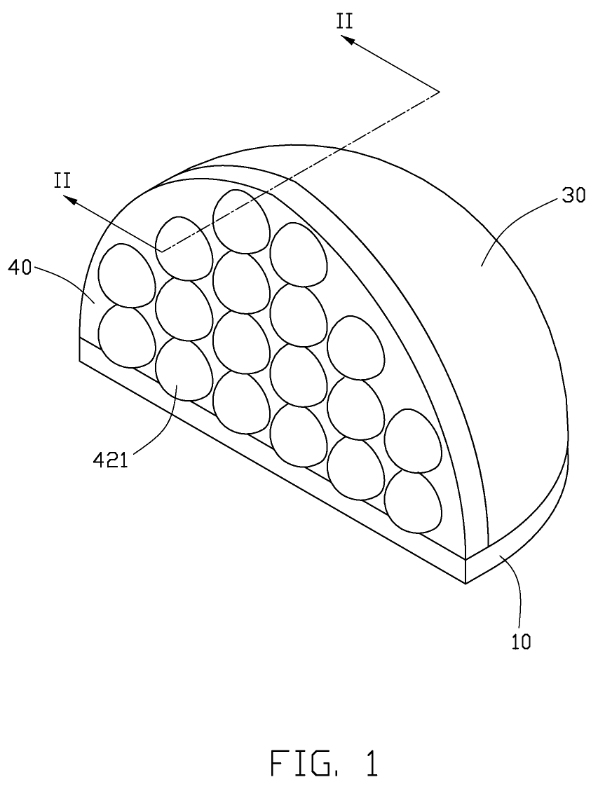

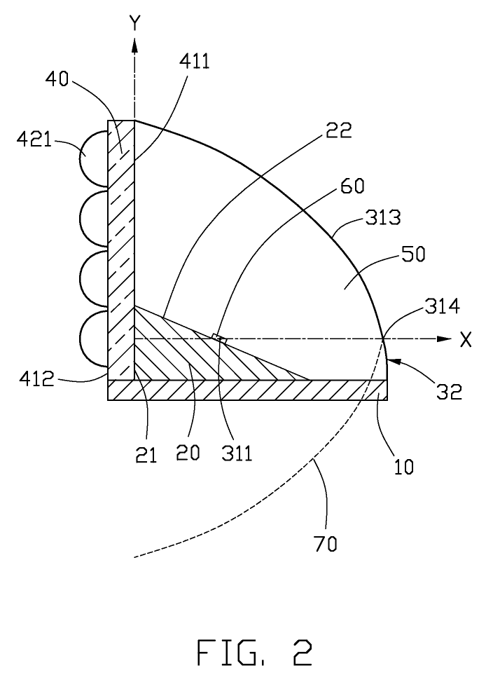

Referring to FIGS. 1 and 2, a light emitting diode (LED) lamp according to an exemplary embodiment includes a substrate 10, a mounting base 20, a reflecting cover 30, a sealing cover 40, and a plurality of LEDs 60 for emitting light.

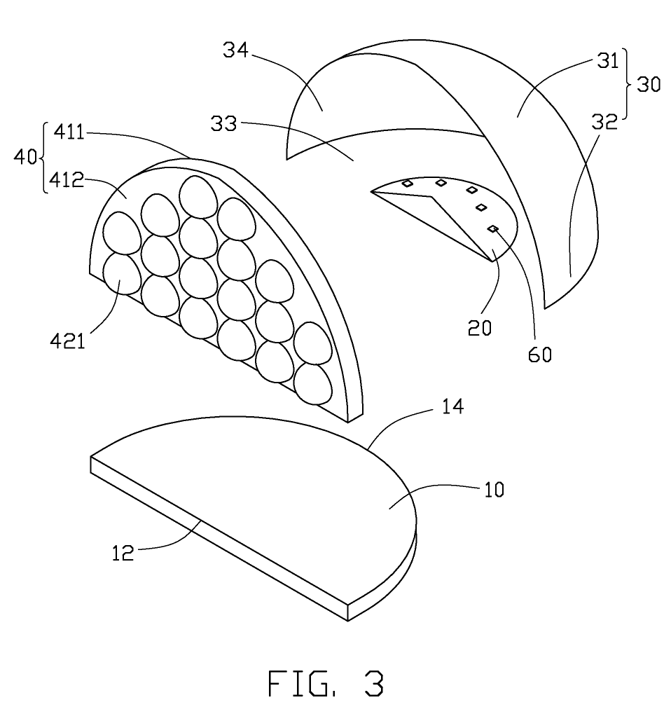

Referring to FIG. 3, the reflecting cover 30 is curved, and includes a reflecting portion 31 and a connecting portion 32. The connecting portion 32 is adapted for connecting the reflecting cover 30 to the substrate 10. The reflecting portion 31 is configured for reflecting the light of the LEDs 60 to ambient, and is coated with a layer of reflecting material, such as mercury. The reflecting portion 31 is formed by revolving a half-parabola 313. Particularly referring to FIG. 2, for clearly defining the reflecting portion 31 of the reflecting cover 30, the Cartesian coordinate system, i.e., the X-Y coordinate system, which includes two perpendicular directed lines (the X-axis and the Y-axis), is used to determine the half-parabola 313. The half-parabola 313 is part of a parabola 70 which is symmetric to the X-axis. A vertex 314 of the parabola 70 is located on the X-axis. The half-parabola 313 extends from the vertex 314 to the Y-axis, and rotates around the Y-axis to form the reflecting portion 31.

In this embodiment, the half-parabola 313 rotates 180 degrees around the Y-axis to form the reflecting portion 31. The vertex 314 rotates around the Y-axis to form a semi-circular at a bottom of the reflecting portion 31, and thus a first open side 33 is defined at the bottom of the reflecting portion 31 of the reflecting cover 30. In addition, the outmost two half-parabolas 313 of the reflecting portion 31 are symmetric to the Y-axis and are coplanar with the Y-axis. A second open side 34 is thus formed at a left side of the reflecting portion 31 of the reflecting cover 30. The second open side 34 is perpendicular to the first open side 33. The connecting portion 32 extends integrally and downwardly from the first open side 33 of the reflecting portion 31 to the substrate 10. Cooperatively the connecting portion 32 and the reflecting portion 31 form the glazed and curved reflecting cover 30.

The sealing cover 40 is coupled to the left open side 34 of the reflecting portion 31 and seals the left open side 34 of the reflecting portion 31. The sealing cover 40 has a shape and size conforming to the left open side 34 of the reflecting cover 30, a bottom side of the sealing cover 40 is coplanar with a bottom side of the connecting portion 32 of the reflecting cover 30. The sealing cover 40 is made of transparent materials, such as resin or glass. An inner side 411 of the sealing cover 40 facing the reflecting cover 30 acts as an incident surface for the light of the LEDs 60 entering into the sealing cover 40, and an outer side 412 of the sealing cover 40 opposite to the inner side 411 acts as an emitting surface for the light of the LEDs 60 emitting to ambient from the sealing cover 40. A plurality of lenses 421 are arranged on the outer side 412 of the sealing cover 40 for enhancing a light emitting directionality of the LEDs 60. The lenses 421 are evenly spaced from each other, and are integrally formed with the sealing cover 40.

The substrate 10 couples to the bottom side of the reflecting cover 30 and the bottom side of the sealing cover 40 to seal the bottom side of the reflecting cover 30. A sealed space 50 is thus formed among the sealing cover 40, the reflecting cover 30 and the substrate 10. The substrate 10 is semi-circular shaped, and has a linear-shaped side 12 on which the sealing cover 40 is arranged, and an arc-shaped side 14 on which the reflecting cover 30 is arranged. The mounting base 20 is received in the space 50 and arranged on the substrate 10. The mounting base 20 is semi-conical, and includes a triangular-shaped left side surface 21 attaching to the inner side 411 of the sealing cover 40, and an arc-shaped mounting surface 22 facing the reflecting cover 30.

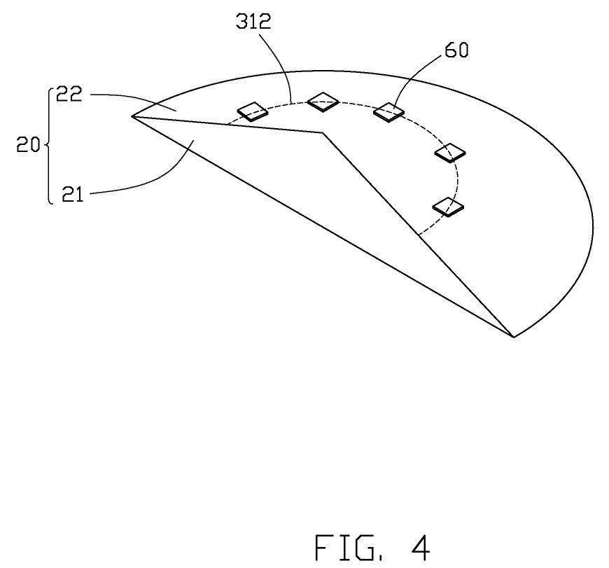

Referring to FIGS. 2 and 4, each parabola 70 has a focal point 311 on the X-axis, and the focal points 311 of all of the parabolas 70 form a semi-circular trajectory 312. The trajectory 312 is located on the mounting surface 22 of the mounting base 20. The LEDs 60 are arranged on the mounting base 20 and located on the trajectory 312. The LEDs 60 are evenly spaced from each other, and each LED 60 confronts to the reflecting cover 30. During operation of the LED lamp, firstly, the light of the LEDs 60 travels to the reflecting cover 30. Since the LEDs 60 are located on the focal points 311 of the parabolas 70 on which the reflecting portion 31 of the reflecting cover 30 is formed, the light reflected from the reflecting portion 31 of the reflecting cover 30 is parallel to each other. Then the reflected parallel light travel through the sealing cover 40 to the ambient. Thus the LED lamp acts as a surface light source, an intensity of the light field of the LED lamp is substantially even.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting diode (LED) lamp, comprising:
a reflecting cover having a reflecting portion formed by rotating a half-parabola around a Y-axis to obtain a plurality of half-parabolas on the reflecting portion, a plurality of whole parabolas each of which has a corresponding half-parabola having a vertex and a focal point located on an X-axis perpendicular to the Y-axis, the half-parabola extending from the vertex to the Y-axis, the focal points of the parabolas forming an arc-shaped trajectory, the vertexes of the parabolas forming an arc and defining a first open side of the reflecting cover, and two outmost half-parabolas of the reflecting portion forming a second open side of the reflecting cover;
a substrate coupling to and sealing the first open side of the reflecting cover;
a transparent sealing cover coupling to and sealing the second open side of the reflecting cover;
a mounting base being received in a sealed space defined among the substrate, the sealing cover, and the reflecting cover, the trajectory being located on an outer surface of the mounting base; and
a plurality of LEDs located on the trajectory and facing the reflecting cover, light emitted by the plurality of the LEDs travelling to the reflecting portion of the reflecting cover and then being reflected parallelly therefrom to the sealing cover.

2. The LED lamp of claim 1, wherein a plurality of lenses are arranged on an outer side of the sealing cover.

3. The LED lamp of claim 2, wherein the plurality of lenses are integrally formed with the sealing cover and are evenly spaced from each other.

4. The LED lamp of claim 1, wherein the mounting base is semi-conical, and comprises a triangular-shaped side surface and an arc-shaped mounting surface facing the reflecting portion, the trajectory being located on the mounting surface of the mounting base.

5. The LED lamp of claim 4, wherein the side surface of the mounting base abuts an inner side of the sealing cover opposite to the outer side.

6. The LED lamp of claim 1, wherein the reflecting portion is formed by rotating the half-parabola for 180 degrees around the Y-axis.

7. The LED lamp of claim 1, wherein the reflecting cover further comprises a connecting portion extending from the arc of the reflecting portion to the substrate, the substrate being semi-circular, the sealing cover being arranged on a linear-shaped side of the substrate, and the reflecting cover being arranged on an arc-shaped side of the substrate.

8. The LED lamp of claim 1, wherein the first open side is perpendicular to the second open side.

9. An LED lamp, comprising:
a reflecting portion formed by rotating a half-parabola around a Y-axis to obtain a plurality of half-parabolas on the reflecting portion, the half-parabola having a vertex and a focal point located on an X-axis perpendicular to the Y-axis, and extending from the vertex to the Y-axis, the focal points of the half-parabolas of the reflecting portion forming an arc-shaped trajectory; and
at least one LED located on the trajectory and confronting to the reflecting portion, light emitted from the at least one LED being reflected by the reflecting portion as parallel light.

10. The LED lamp of claim 9, wherein a first open side is formed at a bottom side of the reflecting portion by the vertexes of the half-parabolas of the reflecting portion, and a second open side is formed at a lateral side of the reflecting portion by two outmost half-parabolas of the reflecting portion, the second open side being perpendicular to the first open side, the parallel light reflected by the reflecting portion travelling to ambient through the second open side of the reflecting portion.

11. The LED lamp of claim 10, wherein the half-parabola rotates 180 degree around the Y-axis to form the reflecting portion, and the two outmost half-parabolas of the reflecting portion are coplanar with the Y-axis.

12. The LED lamp of claim 10, wherein a transparent sealing cover couples to and seals the second open side, the sealing cover having an inner side facing the reflected parallel light, and an outer side opposite to the inner side, a plurality of lenses being arranged on the outer side of the sealing cover.

13. The LED lamp of claim 12, wherein a mounting base being arranged at the first open side of the reflecting potion, the mounting base being semi-conical, and comprising a triangular-shaped side surface and an arc-shaped mounting surface facing the reflecting portion, the trajectory being located on the mounting surface of the mounting base.

14. The LED lamp of claim 13, wherein a substrate couples to and seals the first open side of the reflecting portion, the sealing cover and the reflecting portion being arranged on an outer periphery of the substrate, and the mounting base being arranged on the substrate with the side surface thereof abutting the inner side of the sealing cover.

15. The LED lamp of claim 14, wherein a connecting portion extends from the bottom open side of the reflecting portion to the substrate to assemble the reflecting portion to the substrate.
